(19) United States
(12) Patent Application Publication
(10) Pub. No.: US 2006/0045192 A1
(43) Pub. Date: Mar. 2, 2006

(54) Method and apparatus for pilot channel transmission and reception within a multi-carrier communication system

(76) Inventor: Hiroshi Hayashi, Nishi-Tokyo (JP)

Correspondence Address: MOTOROLA, INC., 1303 EAST ALGONQUIN ROAD, IL01/3RD, SCHAUMBURG, IL, 60196, US

(21) Appl. No.: 10/926,378

(22) Filed: Aug. 25, 2004

(51) Int. Cl. H04K 1/10

(52) U.S. Cl. 375/260

(57) ABSTRACT

In a communication system where data is transmitted on k sub-carriers and N pilot channels are averaged for coherent demodulation, k+N−1 pilot channels are broadcast on the k sub-carriers. In a first embodiment a first and a last plurality of sub-carriers comprise the additional N−1 pilot channels being broadcast at a second time period. For a second embodiment the first and the last sub-carriers comprise an additional plurality of pilot channels being broadcast at various time periods. Finally, for a third embodiment, each sub-carrier comprises a single pilot channel periodically broadcast, however a receiver utilizes multiple of these pilot channels for coherent demodulation of a single sub-carrier.

### FIELD OF THE INVENTION

The present invention relates generally to communication systems, and in particular, to a method and apparatus for pilot channel transmission and reception within a multicarrier communication system.

### BACKGROUND OF THE INVENTION

Pilot assisted modulation is commonly used for communication systems. For an Orthogonal Frequency Division Multiplexed (OFDM) communication system, a pilot per sub-carrier is generally broadcast, providing channel estimation to aid in subsequent demodulation of a transmitted signal. Several pilot assisted modulation schemes are utilized by communication systems, and typically comprise broadcasting a known sequence at known time intervals. A receiver, knowing the sequence and time interval, utilizes this information in demodulating/decoding subsequent non-pilot broadcasts.

In order to improve coherent demodulation, the adjacent (i.e., adjacent in frequency and/or time) pilot channel gains are averaged to reduce noise. While this technique may work well with sub-carriers existing within the middle of the frequency band, this technique is not available at the band edges due to the lack of adjacent frequencies. Therefore, the estimation accuracies at the band edges are degraded due to reduction of number of pilot carriers to be averaged. This is illustrated in FIG. 1 where sub-carriers 101 through 105 have pilot channels 1-5, respectively, broadcast periodically. For purposes of example, assume that a receiver utilizes two adjacent pilot channels for coherent demodulation. Then a receiver receiving sub-carrier 103 will use an average gain of pilot 2, pilot 3, and pilot 4 for coherent demodulation. As discussed, this technique will not be available at the band edges, since sub-carrier 101 will only have one adjacent pilot channel (namely pilot channel 2). This can degrade coherent demodulation at the sub-carriers existing at the frequency band's edge. Therefore, a need exists for a method and apparatus for pilot-channel transmission and reception that allows for improved coherent demodulation for the sub-carriers existing at the frequency band's edge.

### BRIEF DESCRIPTION OF THE DRAWINGS

FIG. 1 illustrates prior-art pilot channel transmissions.

FIG. 2 is a block diagram of an OFDM communication system.

FIG. 3 illustrates OFDM transmission.

FIG. 4 illustrates pilot channel transmission in accordance with a first embodiment of the present invention.

FIG. 5 illustrates pilot channel transmission in accordance with a second embodiment of the present invention.

FIG. 6 illustrates pilot channel transmission in accordance with a third embodiment of the present invention.

FIG. 7 is a block diagram of an OFDM transmitter.

FIG. 8 is a block diagram of an OFDM receiver.

FIG. 9 is a block diagram of the pilot buffer of FIG. 8 for utilizing the first embodiment of the present invention.

FIG. 10 is a block diagram of the pilot buffer of FIG. 8 for utilizing the second embodiment of the present invention.

FIG. 11 is a block diagram of the pilot buffer of FIG. 8 for utilizing the third embodiment of the present invention.

FIG. 12 is a block diagram of the pilot filter of FIG. 8.

FIG. 13 is a flow chart showing operation of the OFDM transmitter of FIG. 7.

FIG. 14 is a flow chart showing operation of the OFDM transmitter of FIG. 8.

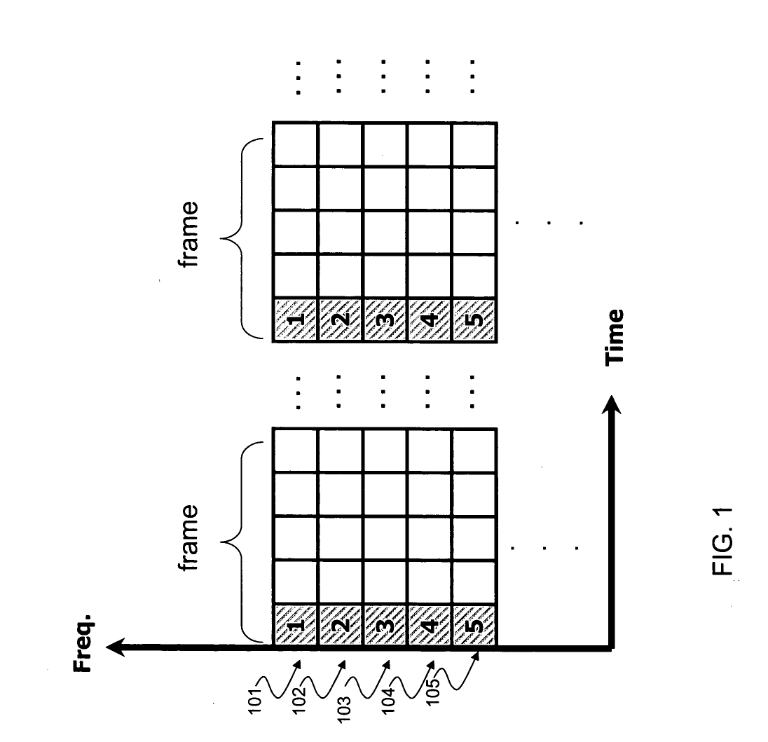

### DETAILED DESCRIPTION OF THE DRAWINGS

To address the above-mentioned need a method and apparatus for pilot-channel transmission is provided herein. More particularly, for a first embodiment a first and a last plurality of sub-carriers comprise additional pilot channels being broadcast at a second time period. For a second embodiment the first and the last sub-carriers comprise an additional plurality of pilot channels being broadcast at various time periods. Finally, for a third embodiment, each sub-carrier comprises a single pilot channel periodically broadcast, however a receiver utilizes multiple of these pilot channels for coherent demodulation of a single sub-carrier, with some pilot channels being used multiple times. By transmitting additional pilots on a single sub-carrier, and by utilizing more than a single pilot channel for coherent demodulation, pilot channel gains can be averaged for all carriers in order to reduce noise.

The present invention encompasses a method for pilot channel transmission in a multi-carrier communication system where N pilot channels are averaged for coherent demodulation. The method comprises the steps of receiving pilot bits at a switch, receiving data at the switch, and formatting sub-carriers such that all sub-carriers comprise a pilot channel being broadcast at a first time period, and a first and a last plurality of sub-carriers comprise an additional pilot channel being broadcast at a second time period.

The present invention additionally encompasses a method for receiving pilot channel data in a multi-carrier communication system where N pilot channels are averaged for coherent demodulation. The method comprises the steps of receiving k+(N−1) pilot channels broadcast on k sub-carriers, and utilizing the k+(N−1) pilot channels broadcast on k sub-carriers for coherent demodulation.

The present invention additionally encompasses a method comprising the steps of receiving k pilot channels broadcast on k sub-carriers, and for a first plurality of sub-carriers, averaging adjacent pilot channels on each side of a sub-carrier for coherent demodulation, while for a second plurality of sub-carriers existing at a wideband channel's edge, averaging multiple copies of a pilot channel for coherent demodulation.

The present invention additionally encompasses an apparatus comprising a plurality of switches receiving data and pilot bits, and logic circuitry operating the switches to format sub-carriers such that all sub-carriers comprise a pilot channel broadcast at a first time period, and a first and a last plurality of sub-carriers comprise an additional pilot channel being broadcast at a second time period.

The present invention additionally encompasses an apparatus existing in a multi-carrier communication system where N pilot channels are averaged for coherent demodulation. The apparatus comprises a multi-carrier receiver receiving k sub-carriers comprising S pilot channels, where S>k, a pilot buffer receiving the k sub-carriers and outputting the S pilot channels, and a pilot filter receiving the S pilot channels, and for each of the k sub-carriers, outputting an average pilot channel value.

The present invention additionally encompasses an apparatus comprising a pilot buffer comprising having k sub-carriers as an input and an output comprising k+(N−1) pilot channels.

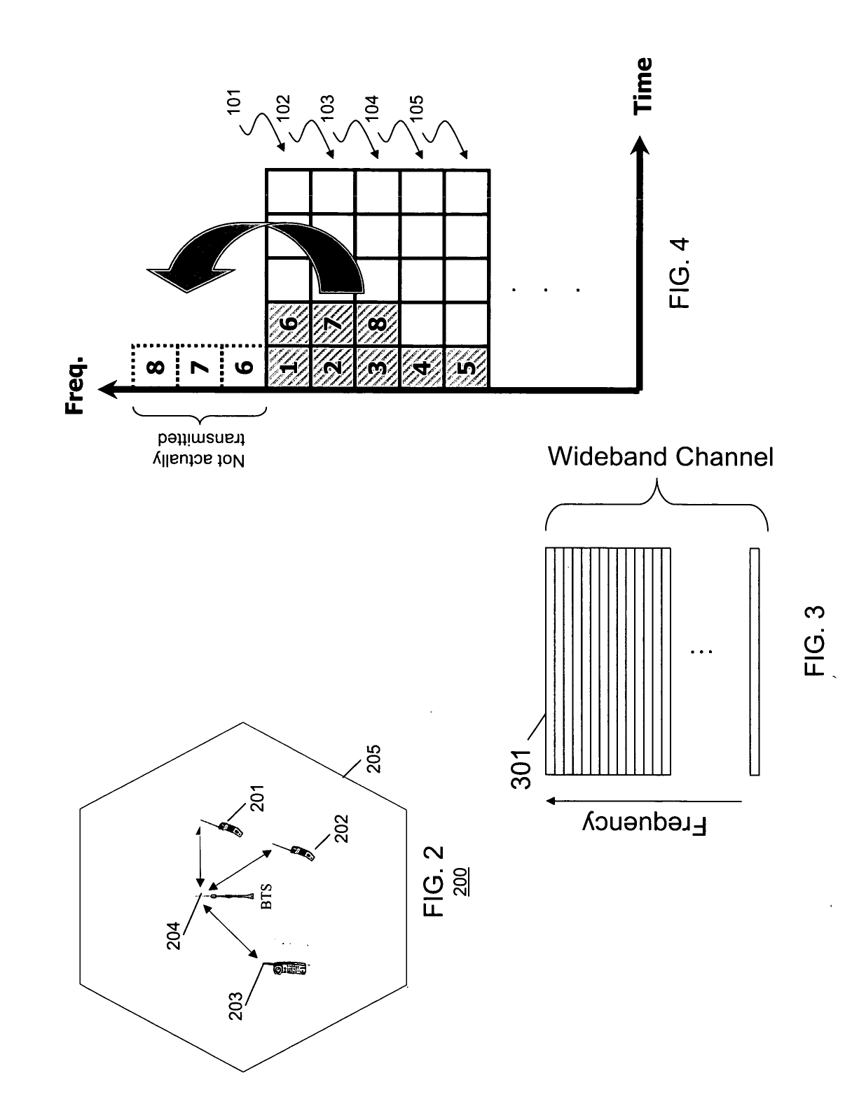

Turning now to the drawings, wherein like numerals designate like components, FIG. 2 is a block diagram of multi-carrier communication system 200. Communication system 200 comprises a plurality of cells 205 (only one shown) each having a base transceiver station (BTS, or base station) 204 in communication with a plurality of remote, or mobile units 201-203. In the preferred embodiment of the present invention, communication system 200 utilizes an OFDM over-the-air protocol. Communication system 200 may also include the use of multi-carrier spreading techniques such as multi-carrier CDMA (MC-CDMA), multi-carrier direct sequence CDMA (MC-DS-CDMA), Orthogonal Frequency and Code Division Multiplexing (OFCDM) with one or two dimensional spreading, or may be also combined with simpler time and/or frequency division multiplexing/multiple access techniques.

As one of ordinary skill in the art will recognize, during operation of an OFDM communication system, multiple sub-carriers (e.g., 768 sub-carriers) are utilized to transmit wideband data. This is illustrated in FIG. 3. As shown in FIG. 3 the wideband channel is divided into many narrow frequency bands, or sub-carriers 301, with data being transmitted in parallel on sub-carriers 301. At the transmission time, a transmitter is typically assigned a plurality of sub-carriers. As discussed above, pilot assisted modulation is commonly used for communication systems. For an OFDM communication system, a single pilot per sub-carrier is generally broadcast, providing channel estimation to aid in subsequent demodulation of a transmitted signal. The pilot is repeated every x time periods, where, for example x=8.

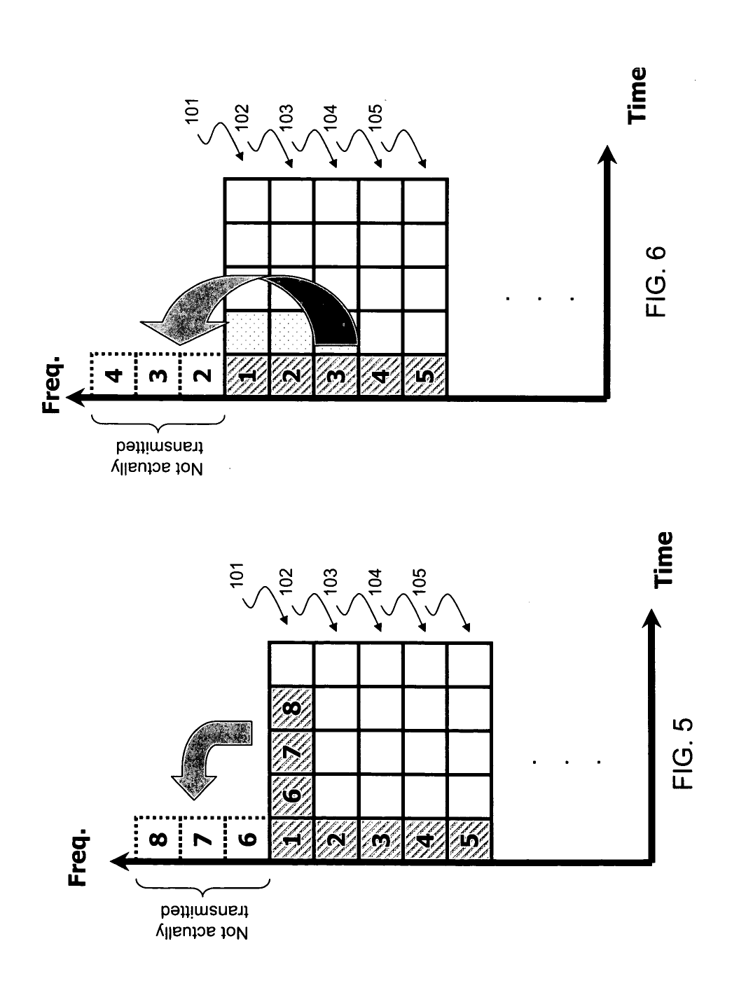

As also discussed, pilot-channel averaging is generally unavailable for those sub-carriers existing at the wideband channel's edge because adjacent pilot channels do not exist. In order to address this issue, in a first two embodiments, additional pilot channels are broadcast to aide in coherent demodulation and in a third embodiment, already-broadcast pilot channels are utilized to aide in coherent demodulation, with some already-broadcast pilot channels being reused to simulate adjacent pilot channels. This is illustrated in FIG. 4, FIG. 5, and FIG. 6. It should be noted that in FIG. 4, FIG. 5, and FIG. 6, only one edge of the wideband channel is shown; however, pilot channel insertion takes place identically at both wideband channel edges.

FIG. 4 illustrates pilot channel transmission/reception in accordance with a first embodiment of the present invention. As is evident, additional pilot channels 6, 7, and 8 are broadcast on only those sub-carriers existing at the wideband channel's edge. In the first embodiment of the present invention, if a total of N pilot channels are averaged to improve channel estimation (where N is odd), then the first and the last (N−1)/2 sub-carriers comprise an additional pilot channel being broadcast at a second time period. These additional pilot channels are utilized by a receiver as if they where broadcast on adjacent channels. Thus, in the first embodiment of the present invention all sub-carriers have a first pilot channel being broadcast at a first time period, however, an additional pilot channel is broadcast at a second time period for the first and the last (N−1)/2 sub-carriers.

FIG. 5 illustrates pilot channel transmission/reception in accordance with a second embodiment of the present invention. As is evident, additional pilot channels 6, 7, and 8 are broadcast only on the two sub-carriers existing at the wideband channel's edge. In the second embodiment of the present invention, if a total of N pilot channels are averaged for coherent demodulation purposes, then the first and the last sub-carriers comprise an additional (N−1)/2 pilot channels being broadcast at (N−1)/2 time periods. These additional pilot channels are utilized by a receiver as if they where broadcast on adjacent channels. Thus, in the second embodiment of the present invention all sub-carriers have a first pilot channel being broadcast at a first time period, however, an additional (N−1)/2 pilot channels are broadcast on each of the first and the last sub-carriers existing at the wideband channel's edge.

As is evident, in the first two embodiments, additional pilot channels are broadcast for sub-carriers existing at the edge of the wideband channel. These additional pilots are averaged by a receiver in order to aide in coherent demodulation. However, in the third embodiment of the present invention, a receiver utilizes an already-transmitted pilot channel multiple times to aide in coherent demodulation. In particular, a receiver will utilize a plurality of pilot channels a single time, and a plurality of pilot channels multiple times to aide in coherent demodulation. This is illustrated in FIG. 6, where N=7, and pilot channels 2, 3, and 4 are utilized multiple times to simulate additional transmissions at the edge of the wideband channel. In this example, sub-carrier 101 will utilize the pilot channel gains of pilot channel 1-4 to aide in coherent demodulation, however, pilot channels 2-4 will be utilized multiple times. In a similar manner, subcarrier 102 will utilize pilot channels 1-5 to aide in coherent demodulation, however, pilot channels 1 and 3 will be utilized multiple times. It should be noted, that while the example given above simulated retransmission of pilot channels 2, 3, and 4, in alternate embodiments of the present invention, any pilot channel may be utilized multiple times to aide in demodulation.

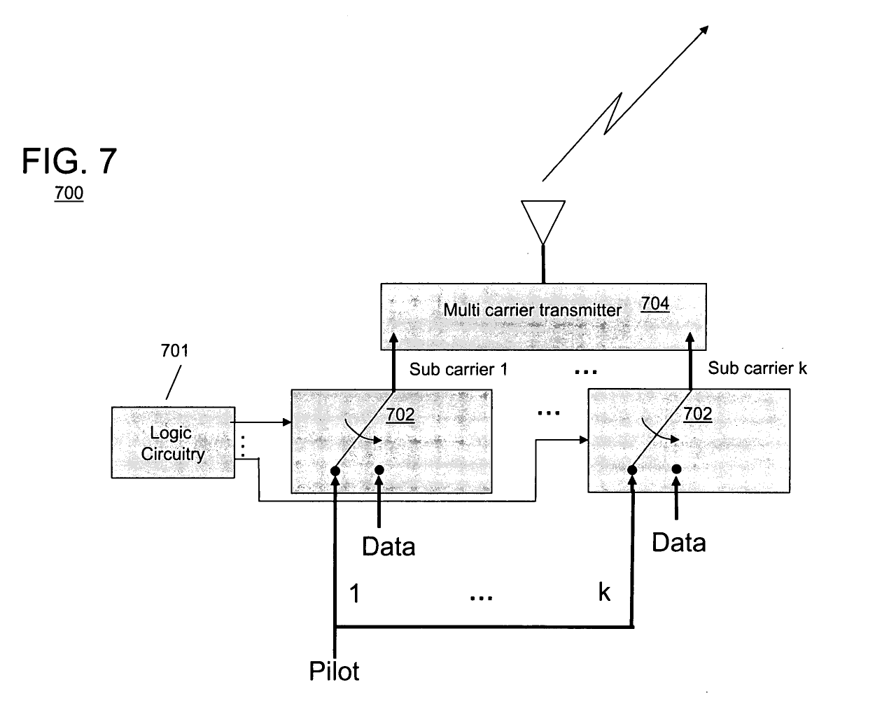

FIG. 7 is a block diagram of OFDM transmitter 700 that can utilize any one of the above-mentioned pilot transmission schemes. As shown, multi-carrier transmitter 704 receives data and pilot information from k subcarriers. The format of any particular subcarrier is controlled via a microprocessor/controller (i.e., logic circuitry 701) controlling switches 702. Thus, as shown, pilot bits and data are provided to each switch 702. Switches 702 control the subcarrier format by periodically switching between data and pilot information. The controlling of switches 702 by circuitry 701 is such that a frame format as shown in FIG. 4, FIG. 5, or FIG. 6 is achieved. Thus, sub-carriers are formatted such that S pilot channels are broadcast over k sub-carriers, where S>k. The broadcasting is such that all sub-carriers comprise a pilot channel being broadcast at a first time period, and a first and a last plurality of sub-carriers may comprise an additional pilot channel being broadcast at a second time period. More particularly, for a first embodiment the first and the last (N−1)/2 sub-carriers comprise an additional pilot channel being broadcast at a second time period. For a second embodiment the first and the last sub-carriers comprise at least an additional pilot channel being broadcast at a second time period, and preferably comprise an additional (N−1)/2 pilot channels being broadcast at additional time periods. Finally, for the third embodiment, each sub-carrier comprises a single pilot channel periodically broadcast so that k pilot channels are received on the k sub-carriers. Multi-carrier transmitter 704 operates to transmit the data and the pilot channels over the wideband channel.

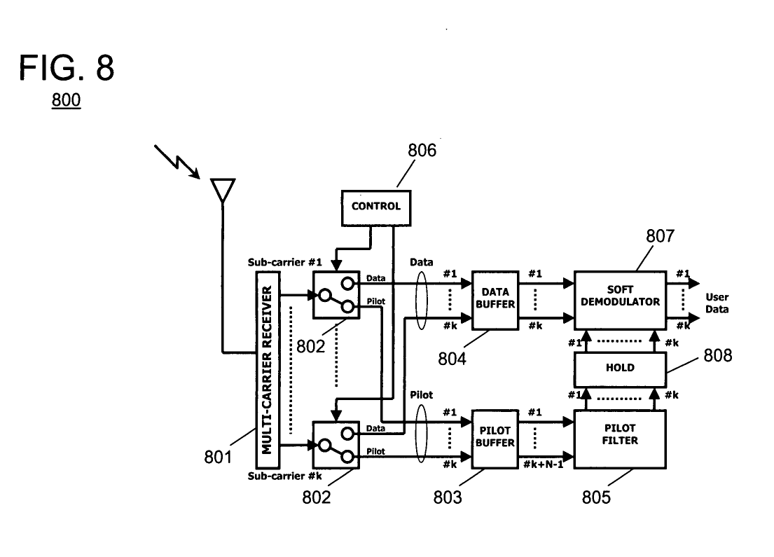

FIG. 8 is a block diagram of OFDM receiver 800 for receiving pilot and data information broadcast from transmitter 700. In the first and the second embodiments S pilot channels are received over k sub-carriers, where S>k, and preferably S=(N−1)+k. As discussed, the S pilot channels are averaged and utilized for coherent demodulation.

Controller 806 operates switches 802, passing received signals to pilot buffer 803 or data buffer 804. More particularly, when controller 806 senses that actual user data is being received, controller 806 operates switches 802 such that the user data is passed to data buffer 804 otherwise, pilot data is passed to pilot buffer 803. As known in the art, there are many ways that controller 806 can sense what type of data is being received. These include blind detection of the data type and explicit signaling of the data type. The explicit signaling of the data type may be in-band or out-of-band signaling, and is typically some form of control signaling. These methods are readily available to use for detecting the location of pilot data.

Pilot buffer 803 stores pilot symbols for each sub-carrier until all the pilot symbols have been received. Simultaneously, data buffer delays the data symbols until pilot averaging is completed. Once pilot data is passed to pilot filter 805, pilot filter 805 averages adjacent pilot symbols (gains) in accordance with the first, second, and third embodiments, and outputs the average pilot symbol gain for all sub-carriers. The averages are held for a frame duration (via hold 808) and utilized by soft demodulator 807 for coherent demodulation of data.

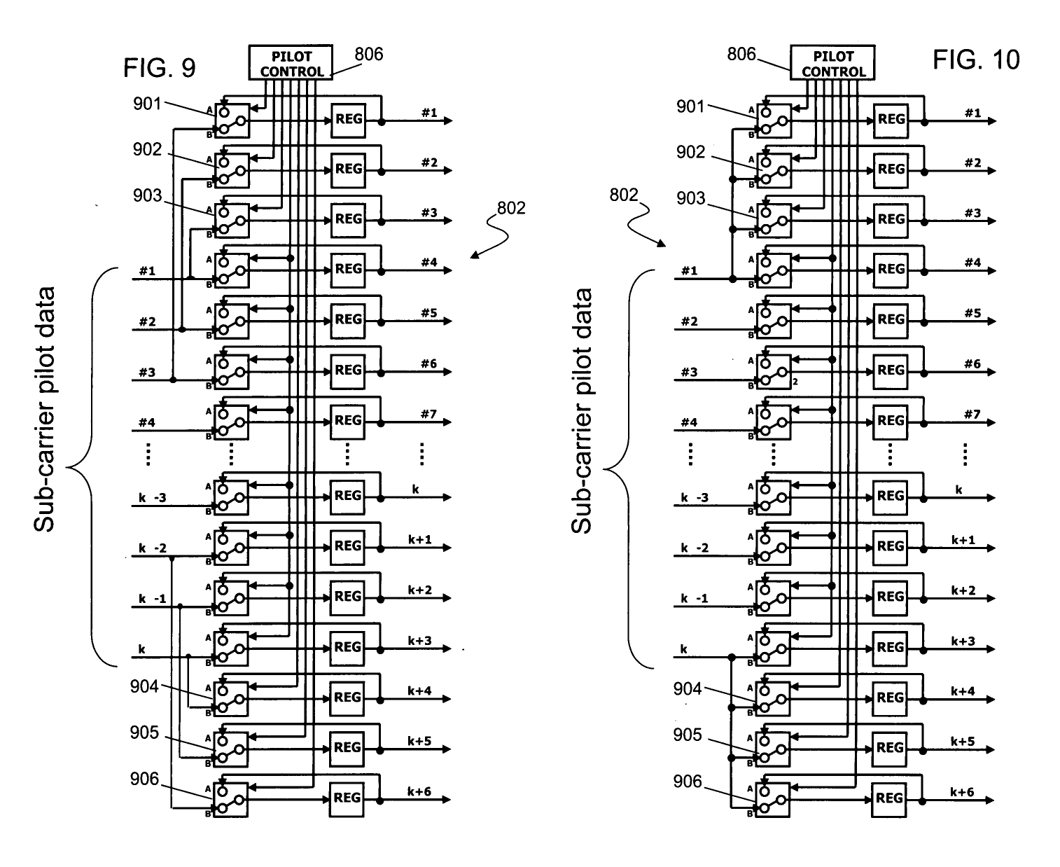

FIG. 9 is a block diagram of pilot buffer 803 for utilizing the first embodiment of the present invention. As is evident pilot data on k sub-carriers is input into buffer 803 and k+(N−1) pilots output buffer 803. In this example N pilot channels are averaged for coherent demodulation purposes (N=7 in this example). As is evident, each sub-carrier has its pilot data fed through one selector and stored in one register. However, the last (N−1)/2 sub-carriers have their pilot data additionally fed to the (N−1)/2 selectors 904-906. This is because an additional (N−1)/2 pilot channels are broadcast on the first and the last (N−1)/2 sub-carriers (as shown in FIG. 4). These additional pilot channels are output by buffer 803 as if they were received on individual sub-carriers outside the wideband channel.

In all embodiments, the register holds data when its selector is set to terminal “A” and is updated when at terminal “B”. Thus, for the first embodiment during the first time slot of the frame, all selectors are set to “B” except for selectors 901-906. In a similar manner, during the second time slot of the frame, all selectors are set to “A” while selectors 901-906 are set to “B”. During all other time slots, all selectors are set to “A”. This is illustrated in table 1.

TABLE 1
Switch states for the first embodiment

Switch

| Time Period | 901-906 | All Other |
|---|---|---|
| 1 | A | B |
| 2 | B | A |
| Else | A | A |

FIG. 10 is a block diagram of pilot buffer 803 for utilizing the second embodiment of the present invention, where N=7 pilot channels are averaged for coherent demodulation purposes. As is evident, each sub-carrier has its pilot data fed through one selector and stored in one register. However, the first and last sub-carriers have their pilot data additionally fed to selectors 901-906. This is because an additional (N−1)/2 pilot channels are broadcast on the first and the last sub-carriers (as shown in FIG. 5). These additional pilot channels are output by buffer 803 as if they were received on individual sub-carriers outside the wideband channel.

As discussed, the register holds data when its selector is set to terminal “A” and is updated when at terminal “B”. For the second embodiment the selectors are updated as illustrated in table 2.

TABLE 2
Selector states for the second embodiment

| | Selector index | | | | | | |
|---|---|---|---|---|---|---|---|
| Time Period | 901 | 902 | 903 | All Other | 904 | 905 | 906 |
| 1 | A | A | A | B | A | A | A |
| 2 | A | A | B | A | B | A | A |
| 3 | A | B | A | A | A | B | A |
| 4 | B | A | A | A | A | A | B |
| Else | A | A | A | A | A | A | A |

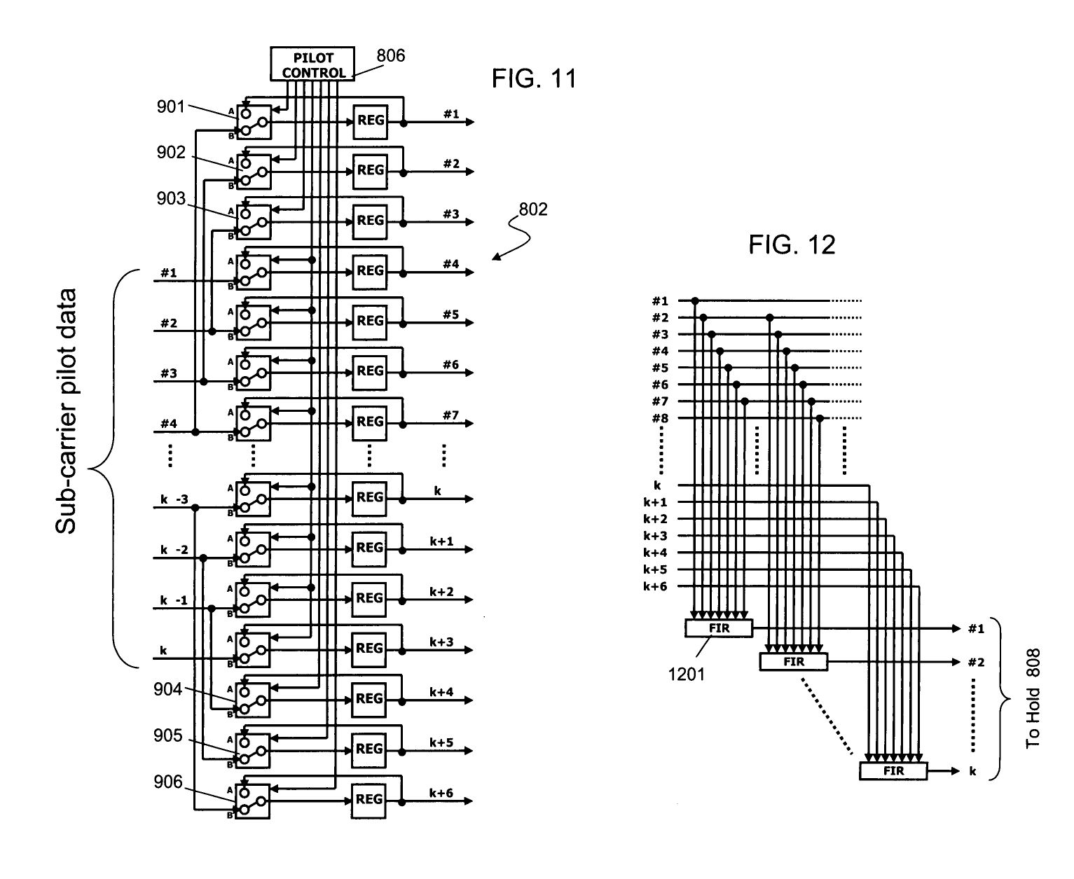

FIG. 11 is a block diagram of pilot buffer 803 for utilizing the third embodiment of the present invention, where N=7 pilot channels are averaged for coherent demodulation purposes. As is evident, each sub-carrier has its pilot data fed through one selector and stored in one register. However, an additional (N−1) sub-carriers have their pilot data additionally fed to selectors 901-906. This is because (N−1) pilot channels are used more than once for averaging (as shown in FIG. 6). The reused pilot channels are output by buffer 803 as if they were received on individual sub-carriers outside the wideband channel.

As discussed, the register holds data when its selector is set to terminal “A” and is updated when at terminal “B”. For the third embodiment the selectors are updated as illustrated in table 3.

TABLE 3
Selector states for the third embodiment

| | Selector index |
|---|---|
| Time Period | All Selectors |
| 1 | B |
| Else | A |

It should be noted that for all described embodiments, pilot data from k sub-carriers are input into pilot buffer 803, where pilot data is stored on k+N−1 buffers/registers. The first and second embodiments have the k sub-carriers comprising k+N−1 pilot channels per frame, where the third embodiment has the k sub-carriers per frame comprising k pilot channels.

FIG. 12 is a block diagram of pilot filter 805. As discussed above, filter 805 averages N adjacent pilot channel gain values, outputting the average gain for each pilot channel. This is accomplished via a plurality of FIR filters 1201, each receiving N pilot channel gain values, and outputting a single average gain value. Thus, for example, sub-carrier 1 will have gain values for the first N pilot outputs from buffer 803 as an input. (In this case N=7). The output of FIR filter 1201 will be the average of the N pilot channel gains.

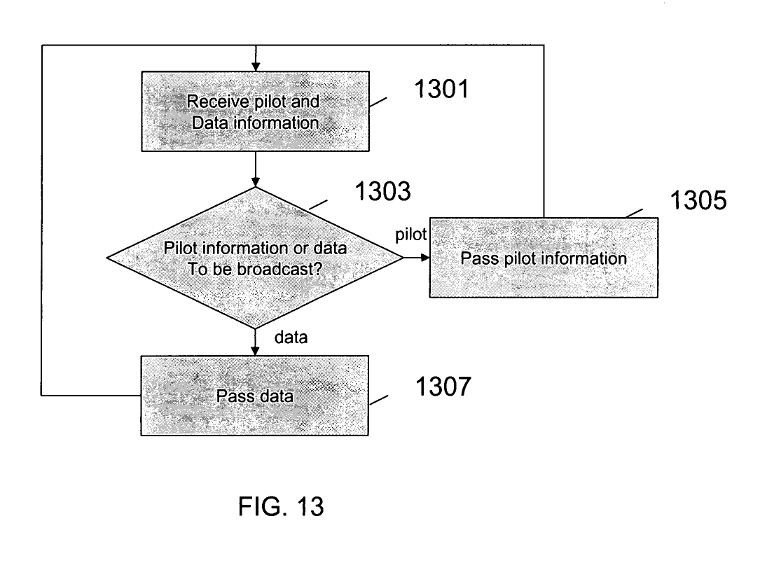

FIG. 13 is a flow chart showing operation of the OFDM transmitter of FIG. 7. In particular, FIG. 13 illustrates those steps necessary for pilot and data transmission to take place on a single sub-carrier. The following steps take place for each sub-carrier. The logic flow begins at step 1301 where pilot and data are received by switch 702. At step 1303, controller 701 determines if a pilot signal should be transmitted on the subcarrier, or if data should be transmitted on the subcarrier. As discussed above, for subcarriers existing at the wideband boundaries, the first and the last (N−1)/2 sub-carriers may comprise an additional pilot channel being broadcast at a second time period. For a second embodiment the first and the last sub-carriers comprise an additional (N−1)/2 pilot channels being broadcast at (N−1)/2 time periods. Finally, for the third embodiment, each sub-carrier comprises a single pilot channel periodically broadcast. Thus, if at step 1303, controller determines that a pilot signal should be transmitted, the logic flow continues to step 1305 where the pilot signal is passed to transmitter 704, otherwise the logic flow continues to step 1307 where data is passed to transmitter 704. For each case, the logic flow then returns to step 1301.

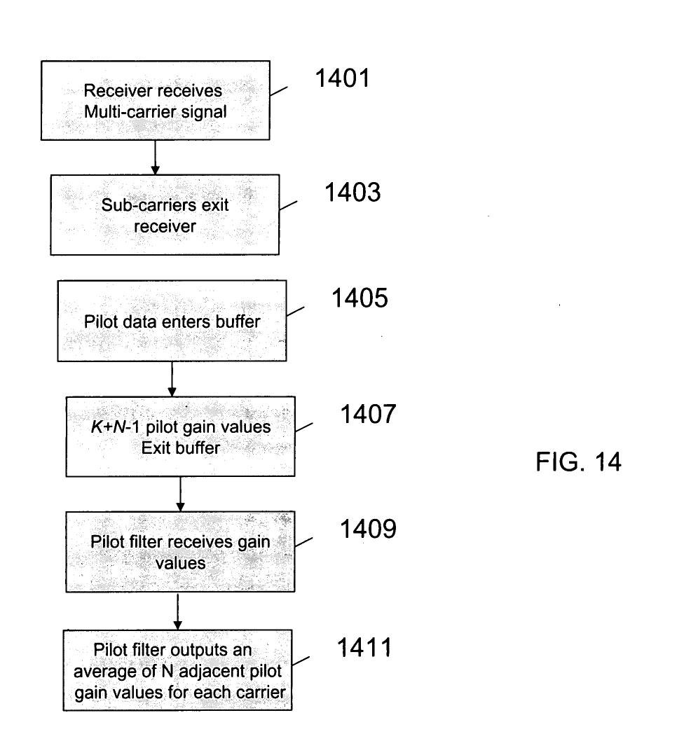

FIG. 14 is a flow chart showing operation of the OFDM receiver of FIG. 8. The logic flow begins at step 1401 where a multi-carrier signal is received by receiver 801. Individual sub-carriers exit multi-carrier receiver 801 at step 1403. Pilot data existing on the k sub-carriers enters pilot buffer 803 at step 1405, and at step 1407 k+N−1 pilot gain values are output from pilot buffer. Pilot filter 805 receives the k+N−1 pilot gain values at step 1409 and for each pilot channel, outputs an average of N adjacent gain value for each pilot channel at step 1411. As discussed above, in order to improve coherent demodulation, the adjacent (i.e., adjacent in frequency and/or time) pilot channel gains are averaged to reduce noise. Because additional pilot channels are broadcast on sub-carriers at the edge of the wideband channel, an average pilot channel gain may be obtained for those sub-carriers existing at the edge of the wideband channel.

While the invention has been particularly shown and described with reference to a particular embodiment, it will be understood by those skilled in the art that various changes in form and details may be made therein without departing from the spirit and scope of the invention. For example, the invention was described for OFDM, but could be applied to any system using multi-carrier modulations. It is intended that such changes come within the scope of the following claims.

1. A method for pilot channel transmission in a multi-carrier communication system where N pilot channels are averaged for coherent demodulation, the method comprising the steps of:
receiving pilot bits at a switch;
receiving data at the switch; and
formatting sub-carriers such that all sub-carriers comprise a pilot channel being broadcast at a first time period, and a first and a last plurality of sub-carriers comprise an additional pilot channel being broadcast at a second time period.

2. The method of claim 1 further comprising the step of:
transmitting the data and the pilot channels over a wideband channel.

3. The method of claim 1 wherein the step of formatting the sub-carriers comprises the step of formatting the sub-carriers so that a first and a last (N−1)/2 sub-carriers comprise an additional pilot channel being broadcast at a second time period.

4. The method of claim 1 wherein the step of formatting the sub-carriers comprises the step of formatting the sub-carriers so that a first and a last sub-carrier comprises at least an additional pilot channel being broadcast at additional time periods.

5. The method of claim 4 wherein the step of formatting the sub-carriers comprises the step of formatting the sub-carriers so that the first and the last sub-carrier comprises an additional (N−1)/2 pilot channels being broadcast at additional time periods.

6. A method for receiving pilot channel data in a multi-carrier communication system where N pilot channels are averaged for coherent demodulation, the method comprising the steps of:
receiving k+(N−1) pilot channels broadcast on k sub-carriers; and
utilizing the k+(N−1) pilot channels broadcast on k sub-carriers for coherent demodulation.

7. The method of claim 6 wherein the step of receiving the k+(N−1) pilot channels broadcast on the k sub-carriers comprises the step of receiving a first and a last plurality of sub-carriers having a pilot channel being broadcast at a first time period and having an additional pilot channel being broadcast at a second time period.

8. The method of claim 7 wherein the step of receiving the k+(N−1) pilot channels broadcast on the k sub-carriers comprises the step of receiving a first and a last (N−1)/2 sub-carriers, each comprising an additional (N−1)/2 pilot channels being broadcast at a second time period.

9. The method of claim 6 wherein the step of receiving the k+(N−1) pilot channels broadcast on the k sub-carriers comprises the step of receiving a first and a last of sub-carrier, each having (N−1)/2 pilot channels being broadcast at additional time periods.

10. A method comprising the steps of:
receiving k pilot channels broadcast on k sub-carriers;
for a first plurality of sub-carriers, averaging adjacent pilot channels on each side of a sub-carrier for coherent demodulation; and
for a second plurality of sub-carriers existing at a wideband channel's edge, averaging multiple copies of a pilot channel for coherent demodulation.

11. An apparatus comprising:
a plurality of switches receiving data and pilot bits; and
logic circuitry operating the switches to format sub-carriers such that all sub-carriers comprise a pilot channel broadcast at a first time period, and a first and a last plurality of sub-carriers comprise an additional pilot channel being broadcast at a second time period.

12. The apparatus of claim 11 wherein a first and a last (N−1)/2 sub-carriers comprise an additional pilot channel being broadcast at a second time period.

13. The apparatus of claim 11 wherein a first and a last sub-carrier comprises at least an additional pilot channel being broadcast at additional time periods.

14. The apparatus of claim 13 wherein the first and the last sub-carrier comprises an additional (N−1)/2 pilot channels being broadcast at additional time periods.

15. An apparatus existing in a multi-carrier communication system where N pilot channels are averaged for coherent demodulation, the apparatus comprising:
a multi-carrier receiver receiving k sub-carriers comprising S pilot channels, where S>k;
a pilot buffer receiving the k sub-carriers and outputting the S pilot channels; and
a pilot filter receiving the S pilot channels, and for each of the k sub-carriers, outputting an average pilot channel value.

16. The apparatus of claim 15 wherein a first and a last plurality of sub-carriers comprise an additional pilot channel being broadcast at a second time period.

17. The apparatus of claim 16 wherein a first and a last (N−1)/2 sub-carriers comprise an additional pilot channel being broadcast at a second time period.

18. The apparatus of claim 15 wherein a first and a last sub-carrier comprises at least an additional pilot channel being broadcast at additional time periods.

19. The apparatus of claim 18 wherein the first and the last sub-carrier comprises an additional (N−1)/2 pilot channels being broadcast at additional time periods.

20. An apparatus comprising:
a pilot buffer comprising having k sub-carriers as an input and an output comprising k+(N−1) pilot channels.

21. The apparatus of claim 20 further comprising:
a pilot filter having the k+(N−1) pilot channels as an input and outputting an average pilot channel value for each sub-carrier.
